(19) United States
(12) Patent Application Publication
(10) Pub. No.: US 2026/0086021 A1
(43) Pub. Date: Mar. 26, 2026

(54) STANDING FORCE-TESTING APPARATUS

(71) Applicant: Spirit AeroSystems, Inc., Wichita, KS (US)

(72) Inventor: Bradly Hilker, Wichita, KS (US)

(21) Appl. No.: 18/894,293

(22) Filed: Sep. 24, 2024

(51) Int. Cl. G01N 19/04

(52) U.S. Cl. CPC G01N 19/04

(57) ABSTRACT

A force-testing apparatus adapted for standing users includes a body with a handle portion, a force detection assembly with a force detector, a plunger, a signal processor, and an indicator. The plunger is coupled to the force detection assembly and is configured to sustain a normal force when an operating force is applied. The signal processor is coupled to the force detector and the indicator. The threshold force detector is configured to detect when the operating force reaches a predetermined threshold force value. The signal processor is configured to transmit an indicator signal to activate the indicator when the predetermined threshold force value has been detected.

### FIELD

The present disclosure pertains to a force-testing apparatus used by standing operators to detect the bond strength of adhesive-bonded fasteners mounted over holes in a structural body.

### BACKGROUND

Adhesive-bonded fasteners (such as CLICK BOND® nutplates and other similar products like nutplate 190 depicted in FIG. 13) provide a convenient way for manufacturers to install a variety of different connectors, studs, bushings, tie mounts, etc. on the surfaces of manufactured structures without the need to rely on cumbersome mechanical fasteners like bolts, rivets, or welds. The process of installing adhesive-bonded fasteners instead of these other types of mechanical fasteners can increase efficiency and productivity in manufacturing environments. A common use of adhesive-bonded fasteners involves installing the fasteners above or below guide holes located in the manufacturing structures (e.g., sheet metal). The installation can be accomplished by applying an adhesive (e.g., an acrylic paste) on the base of the fastener and using a removable installation feature (e.g., a removable silicone fixture) to assist with the alignment and compression of the fastener and adhesive until the adhesive sets. After the adhesive sets, the removable installation feature may be removed, leaving the fastener adhesively bonded to the installation surface.

At the end of the installation process, manufacturers may wish to inspect the installed adhesive-bonded fasteners to check for defects or abnormalities. Because adhesive-bonded fasteners rely on the bond strength of their adhesives, manufacturers may test the bond strength of each adhesive fastening to ensure it is capable of sustaining at least the amount of stress the adhesive is intended to sustain during regular use. Bond strength tools that are commonly used for such testing are often designed as compact, handheld spring-loaded tools. While these handheld tools are simple and portable, they are not user-friendly in large-scale manufacturing settings, particularly with fasteners that are installed in locations that are not within arm's length of the tool operators, as the operators are unable to use the tools efficiently and are not readily able to view the force readings provided by the tools.

### SUMMARY

In one aspect, a force-testing apparatus adapted for standing users includes body with a handle portion, a force detection assembly, a plunger, a signal processor, and an indicator. The force detection assembly is coupled to the body and includes a threshold force detector. The plunger is coupled to the force detection assembly and is configured to sustain a normal force when an operating force is applied to the body generally toward the plunger in a normal direction. The normal force sustained by the plunger opposes the operating force in the normal direction. The signal processor is operatively coupled to the threshold force detector. Additionally, the indicator is operatively coupled to the signal processor. The threshold force detector is configured to detect when the operating force reaches a predetermined threshold force value which may, for example, correspond to a target testing force for testing fasteners that have been adhesively bonded to a manufacturing structure. The signal processor is configured to transmit an indicator signal to activate the indicator when the predetermined threshold force value has been detected.

In some embodiments, the detector can be a position detector that is configured to detect a position of the plunger relative to the body. In further embodiments, the force detection assembly can include a spring placed in yieldable engagement with the plunger, and the detector can detect the predetermined threshold value as corresponding to a threshold compression distance of the spring. In yet further embodiments, the threshold force detector can be configured to detect a position of the plunger relative to the force detection assembly.

In other embodiments, the body can have a body length of at least approximately 30 inches to accommodate a relatively long reach distance for operators. In additional embodiments, the indicator is configured to be visibly, audibly, or otherwise perceived by a standing operator. In yet other embodiments, the indicator is coupled to the handle portion of the body for perception by standing operators. In other embodiments, the indicator can include at least one visual indicator, at least one sound indicator, or any combination of visual indicators and sound indicators.

In yet other embodiments, the plunger of the force-testing apparatus can include a contact end portion. The contact end portion can be configured to extend through an aperture formed in a manufacturing structure to reach a portion of a fastener installed to the manufacturing structure on a distal surface facing generally away from the force-testing apparatus in the normal direction. This configuration allows the force-testing apparatus to be used effectively to test strength metrics such as the pull strength of adhesive-bonded nutplates or other similar fasteners. In further embodiments, the contact end portion can be configured to fit in apertures having a diameter of up to approximately 0.5 inches. In yet other further embodiments, the contact end portion of the plunger is substantially rigid to provide enhanced contact with mounted fasteners.

In additional embodiments, the force-detection assembly may be adjustable so more than one predetermined threshold force value can be detected. In further embodiments, the force detection assembly can be releasably coupled to the body, and the body and force detection assembly can be configured to inhibit adjustment of the force detection assembly while the force detection assembly is coupled to the body. In yet further embodiments, the body can include a shaft portion that is configured to house the force detection assembly so that adjustment is inhibited when the force detection assembly is coupled to the body. In other further embodiments, the force-testing apparatus can include one or more guide lights disposed near the contact end of the plunger and configured to direct light toward the contact end of the plunger so that the force-testing apparatus can be used accurately and effectively even in low-light environments such as corners. In yet other further embodiments, the force-testing apparatus can include a shock cap disposed on a portion of the body near the contact end of the plunger such that the contact end of the plunger extends outward from the shock cap generally in the normal direction. The shock cap can be configured to guard against impacts between the manufacturing structure and the portion of the body to which the shock cap is disposed, for example, when an adhesive-bonded fastener separates from the manufacturing structure and the force-testing apparatus jolts forward during the testing process.

In another aspect, a force-testing apparatus adapted for standing users includes a body, a contact end portion, a force sensor, and an indicator. The body has a handle portion and a shaft portion extending from the handle portion. The shaft portion has a distal end portion and a length extending from the handle portion to the distal end that is at least 18 inches. The contact end is operatively coupled to the shaft portion at the distal end of the shaft portion and is configured to contact a part. The indicator is located on the handle. The contact end portion is configured to be urged against the part by a compressive force applied manually to the handle portion. The force sensor is configured to detect when the compressive force reaches a predetermined threshold force value. Additionally, the indicator is operatively coupled to the force sensor and is configured to indicate when the predetermined threshold value is reached. In a further embodiment, the force sensor is adjustable to multiple different predetermined threshold values.

In yet another aspect, a force-testing apparatus includes a body, a plunger, a signal processor, a position detector, and an indicator. The body includes a handle portion. The plunger is in spring-biased engagement with the body at a distal end of the body opposite the handle portion. The position detector and indicator are operatively coupled to the signal processor. The plunger is configured to sustain a normal force when an operating force is applied to the body generally toward the plunger in a normal direction. The normal force opposes the operating force in the normal direction. The plunger is configured to travel a compression distance relative to the body, the compression distance corresponding to the magnitude of the operating force. The position detector is configured to transmit a detection signal when the plunger travels at least a threshold compression distance corresponding to a predetermined threshold operating force. The signal processor is configured to transmit an activation signal to the indicator when the position detector transmits the detector signal. In a further embodiment, the indicator can be located on the handle of the body, and the indicator can include one or more visual indicators, one or more sound indicators, or any combination of visual and sound indicators.

Other aspects will be in part apparent and in part pointed out hereinafter.

### BRIEF DESCRIPTION OF THE DRAWINGS

FIG. 1 is a perspective of a force-testing apparatus;

FIG. 2 is a perspective of the force-testing apparatus together with an exemplary manufacturing structure;

FIG. 3 is a bottom perspective of a lower fragmented portion of the force-testing apparatus and the exemplary manufacturing structure and an adhesive-bonded fastener secured thereto;

FIG. 4 is a perspective of the body of the force-testing apparatus;

FIG. 5 is a fragmented perspective of an upper portion of the force-testing apparatus including handles and a user interface assembly;

FIG. 6 is an exploded view of the upper portion of the force-testing apparatus of FIG. 5 with the handle grips removed;

FIG. 7 is a perspective of the force detection assembly of the force-testing apparatus of FIG. 1;

FIG. 7A is a magnified portion thereof;

FIG. 8 is a fragmented cross-section of the lower portion of the force-testing apparatus of FIG. 1;

FIG. 9 is an exploded perspective of the force detection assembly and a fragment of the shaft portion of the body of the force-testing apparatus of FIG. 1;

FIG. 10 is a perspective of the force pin of the force-testing apparatus of FIG. 1;

FIG. 11 is an exploded perspective of the sensor module of the force-testing apparatus of FIG. 1;

FIG. 12 is an exploded perspective of the spring enclosure and shock cap of the force-testing apparatus of claim 1;

FIG. 13 is a perspective of the adhesive-bonded fastener of FIG. 3;

FIG. 14 is a fragmented elevation of a lower portion of the force-testing apparatus, the manufacturing structure, and the adhesive-bonded fastener of FIGS. 2 and 3;

FIG. 15 is a cross-section taken through line 15-15 of FIG. 14;

FIG. 15A is a magnified portion thereof;

FIG. 16 is a fragmentary cross-section of the force-testing apparatus depicting an extended position of a free end portion of the force pin relative to the optical sensor of the apparatus;

FIG. 17 is a fragmentary cross-section of the force-testing apparatus depicting a compressed position of the free end portion of the force pin relative to the optical sensor;

FIG. 18 is a schematic block diagram of the control system of the force-testing apparatus of claim 1;

FIG. 19 is a flowchart of process steps for indicating the detection of a predetermined threshold force when the force-testing apparatus is used;

FIG. 20 is a photograph of an alternative force-testing apparatus;

FIG. 21 is a fragmentary perspective of the lower portion of the force-testing apparatus of FIG. 20; and

FIG. 22 is an exploded view of the components of the force-testing apparatus of FIG. 20.

Corresponding reference characters indicate corresponding parts throughout the drawings.

### DETAILED DESCRIPTION

This disclosure generally pertains to a force-testing apparatus which can be used by standing operators. As will be explained in further detail below, the disclosed force-testing apparatus is configured to indicate to users when a threshold force (e.g., a user-defined stress rating) has been applied by the user. In one implementation, the disclosed force-testing apparatus can be used to test the bond strength of hole-mounted, adhesive-bonded fasteners installed on the surfaces of airframe structures (which, broadly, are one type of large-scale manufacturing product). The disclosed force-testing apparatus can include an indicator which indicates to the user when at least the threshold force has been applied (for example, with a visible or audible signal). The disclosed force-testing apparatus may further include a plunger with a contact end portion that can be inserted through fastener alignment holes to engage a base portion of the fastener to which the testing force can be applied. As will be explained in further detail below, the plunger may be coupled to a bias spring and may interact with a detector capable of detecting when at least the threshold force has been applied.

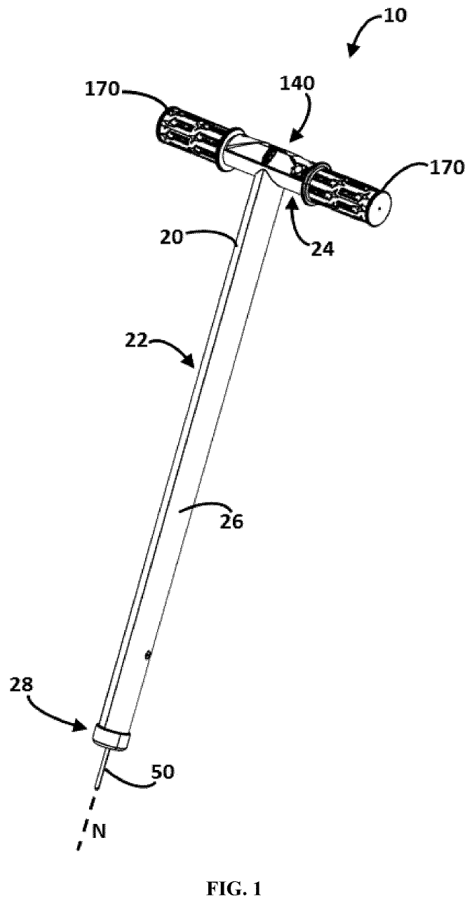

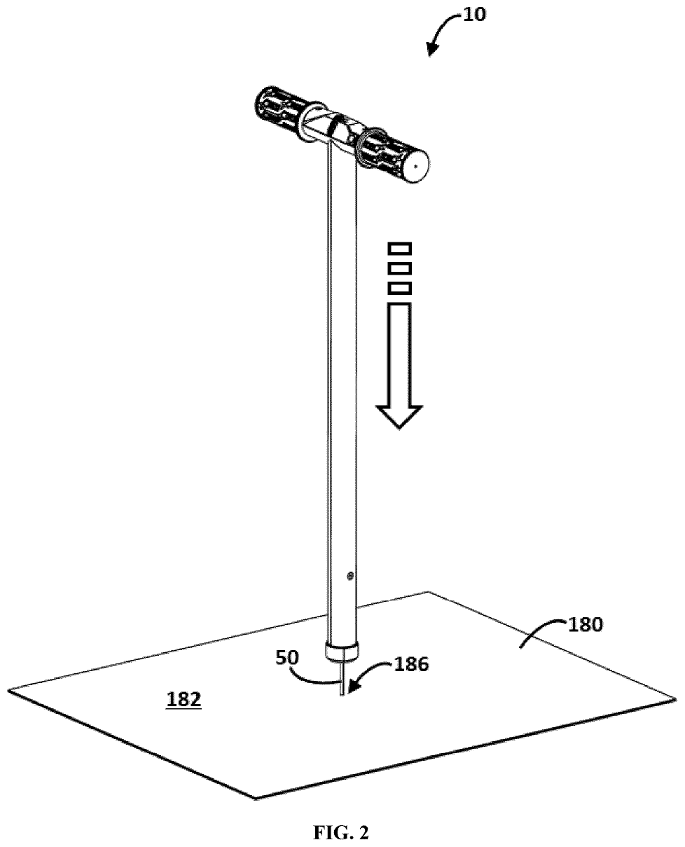

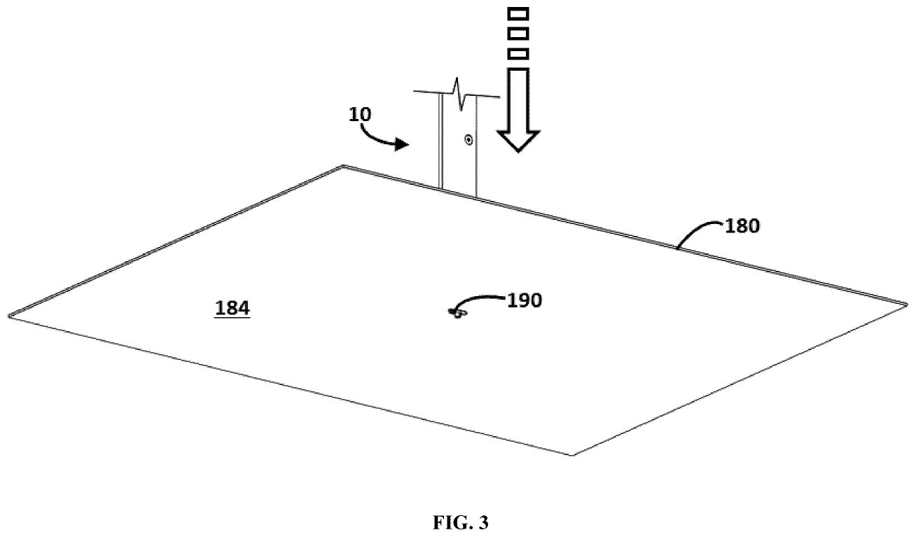

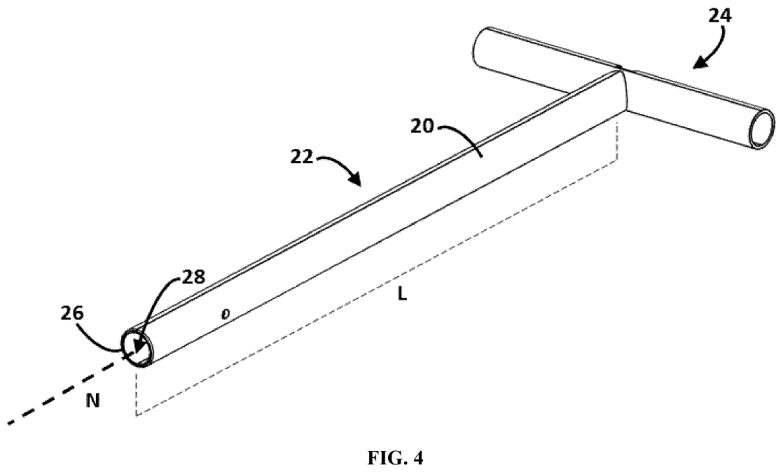

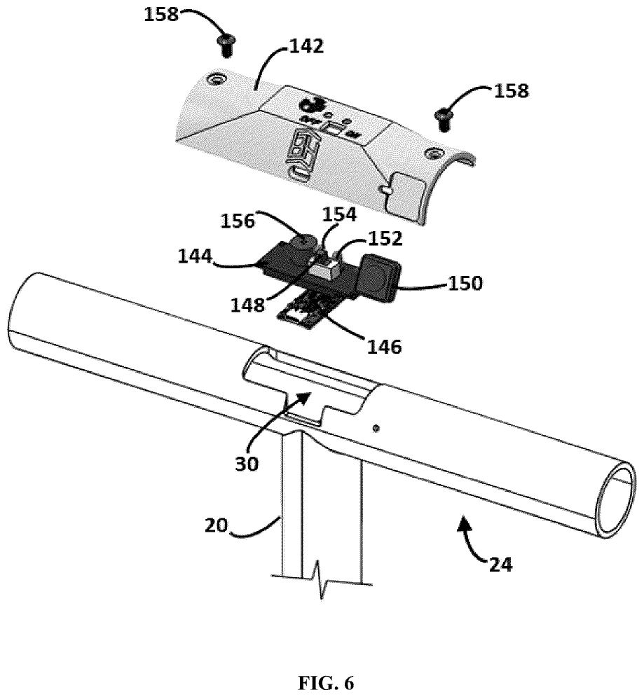

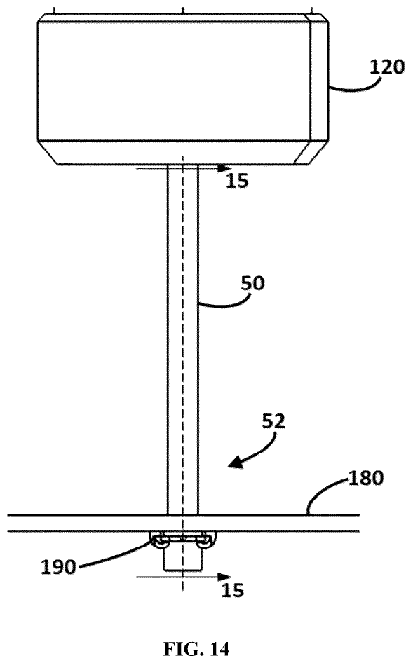

Referring now to FIG. 1, a force-testing apparatus in accordance with an embodiment of the invention is generally indicated at reference number 10. In FIGS. 2-3 and 14-15A, the apparatus 10 is shown in use with a nutplate 190 (more generally, a fastener) bonded to a metal sheet 190 (more generally, a manufacturing structure), as will be explained in greater detail below. The apparatus 10 depicted in FIG. 1 generally includes a body 20 with a shaft portion 22 and a handle portion 24. As further shown in FIG. 4, in an exemplary embodiment, the body 20 can be made of a rigid, lightweight, tubular material such as aluminum, and can comprise a tubular wall such as body wall 26, which defines a lower opening 28 in the shaft portion 22. As additionally shown in FIG. 6, an upper opening 30 can be formed in the handle portion 24 to receive an indicator, which in the illustrated embodiment is a component of the user interface assembly 140 shown in FIGS. 1 and 5-6 and described in greater detail below. As shown in FIG. 4, the shaft portion 22 is generally oriented along a normal axis N and extends a length L along the normal axis. In an exemplary embodiment, the length L of the shaft portion 22 can be dimensioned to facilitate handling by standing operators. For example, length L can be between approximately 30 and 36 inches, though it is contemplated other lengths may be selected depending on user preference.

Referring now to FIGS. 1, 5, and 7, the body 20 of apparatus 10 is configured to support a force detection assembly, which is generally indicated by reference number 40, and a user interface assembly (more generally, an indicator), which is generally indicated by reference number 140. It is contemplated that the force detection assembly 40 and the user interface assembly 140 can be directly or indirectly electronically coupled (e.g., by wired or wireless signal) so that the user interface assembly generally provides users with an indication whenever the force detection assembly detects that a threshold force has been applied to the apparatus 10, as will be described in greater detail below. As will be further explained below, additional features in the force detection assembly 40 and user interface assembly 140 may be interconnected, for example the LEDs 130 and push button switch 150 may be interconnected.

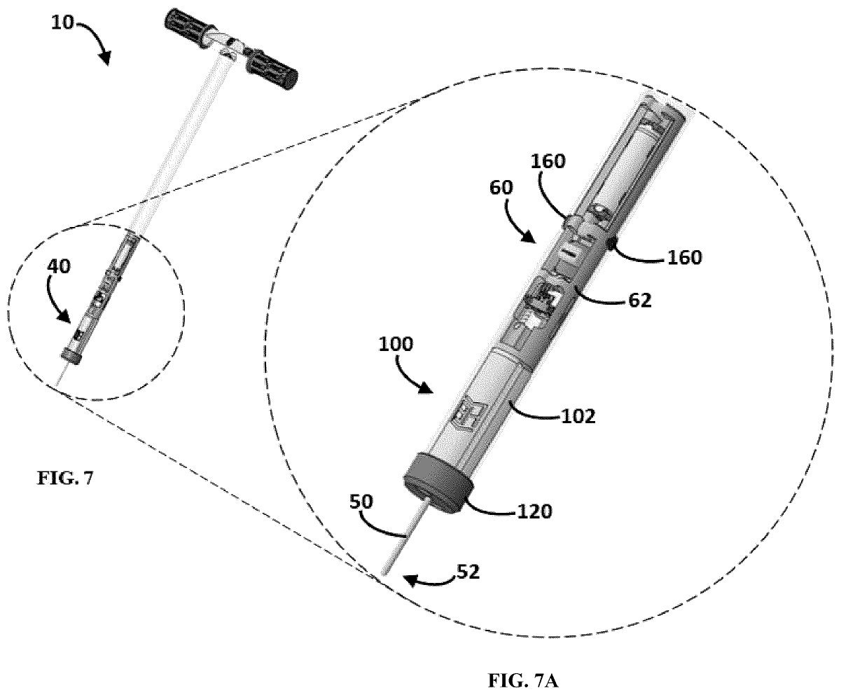

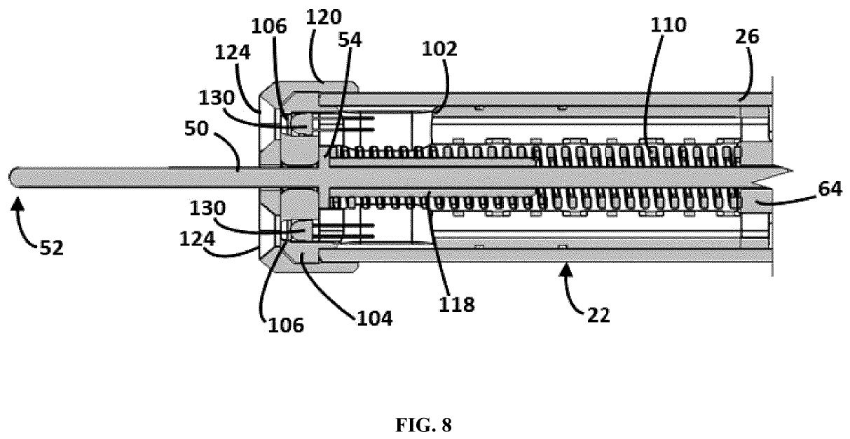

Referring to FIGS. 7-9, the force detection assembly 40 broadly includes a force pin 50 (more generally, a plunger), a sensor module 60 (more generally, an electronic portion), a spring enclosure 100 (more generally, a mechanical portion) that holds a bias spring 110 configured to yieldably bias the force pin toward an extended position, and a shock cap 120 (more generally, a bumper). As seen in FIG. 7A, the sensor module 60 and spring enclosure 100 are configured to fit substantially inside the shaft portion 22 when the apparatus 10 is fully assembled, with the shock cap 120 substantially covering the lower opening 28. Additionally, the spring enclosure 100 is configured to retain the force pin 50 so that a contact end portion 52 of the force pin extends generally outward along the normal axis N relative to the lower opening 28. Referring also to FIG. 8, the force detection assembly 40 houses two white LEDs 130 (more generally, guide lights) which direct light generally in the direction of the contact end portion 52 which can be activated to enhance accuracy and productivity when using the apparatus 10. With reference to FIGS. 7A, 9 and 11-12, the force detection assembly 40 can be removably installed in the shaft portion 22 by securing (e.g., fastening) the sensor module 60 to the spring enclosure 100 with mount screws 112 inserted in threaded inserts 68, inserting the sensor module and spring enclosure into the shaft portion through the lower opening 28, securing the sensor module to the shaft portion (e.g., with mount screws 160 inserted into threaded inserts 68), and fitting the shock cap 120 over the lower opening.

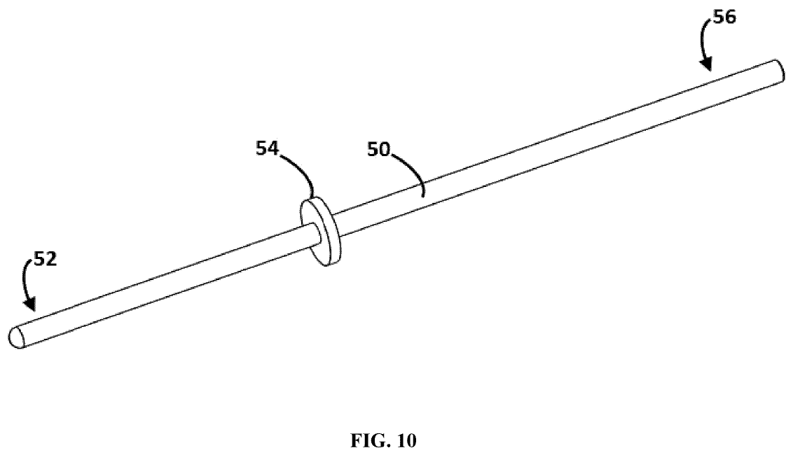

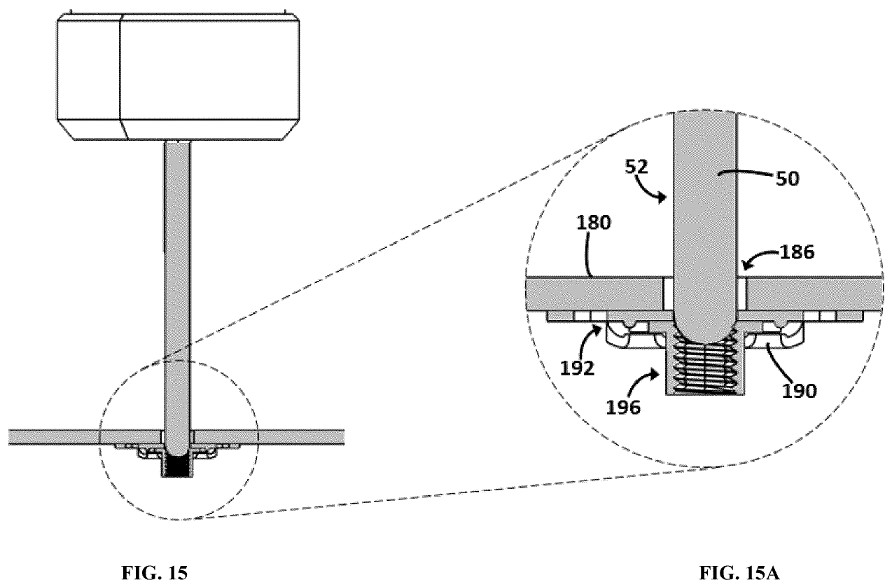

Referring now to FIG. 10, the force pin 50 broadly has a contact end portion 52, a flange 54, and a free end portion 56. In the present embodiment the force pin 50 is a metal rod, and the contact end portion 52 is substantially rigid so it does not deform when force is applied. The contact end portion 52 can be configured to fit in fastener mounting holes having a diameter between approximately 0.25 inches and approximately 0.5 inches, such as alignment hole 186 discussed below in connection with FIGS. 2 and 15A. It is contemplated that in alternative embodiments, other plunger elements that include a substantially rigid contact end could be used in a similar manner without departing from the scope of the invention.

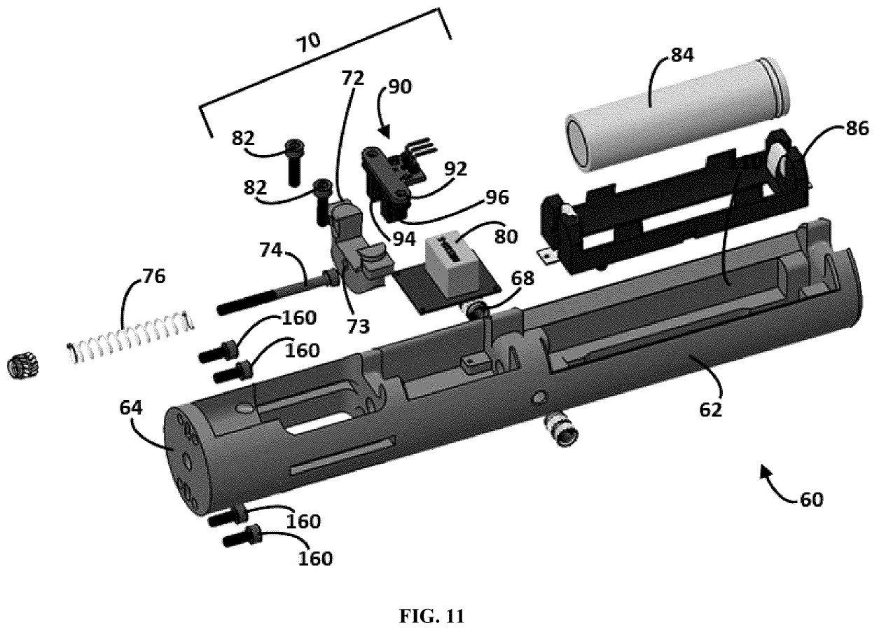

Referring now to FIG. 11, the sensor module 60 broadly includes a sensor module housing 62, an adjustable sensor support assembly 70 (more generally, an adjustment mechanism), a controller 80 (more generally, a signal processor), a battery cell 84 (more generally, a power supply), and an optical position sensor 90 (more generally, a detector). The sensor module housing 62 includes a generally flat sensor module housing base 64 which serves as an upper stop for the bias spring 110 and includes a travel passage 66 through which the free end portion 56 of force pin 50 is generally able to move as force is applied. Additionally, the sensor module housing includes threaded inserts 68 for receiving the mount screws 160 described in greater detail below. The adjustable sensor support assembly 70 includes a sensor mount 72 with a through-hole 73, an adjustment screw 74 (more generally, a positioning element) whose shaft can be inserted through the through-hole, one or more compression springs 76 (more generally, a bias element) configured to yieldably bias the sensor mount 72 proximally into engagement with the head of the adjustment screw 74, and a threaded insert 78 configured to threadably engage the adjustment screw 74. The adjustable sensor support assembly 70 can be adjusted to a user-defined position by rotating the adjustment screw 74 inward or outward relative to the module housing 62. The battery cell 84, which generally provides power to electronic components such as the controller 80 and optical sensor 90, is configured to be inserted in a cell holder 86 affixed to the sensor module housing 62. The optical sensor 90 broadly comprises an encoder 92, a first diode 94, and a second diode 96. The encoder 92 is mounted to the sensor mount 72 via encoder mount screws 82.

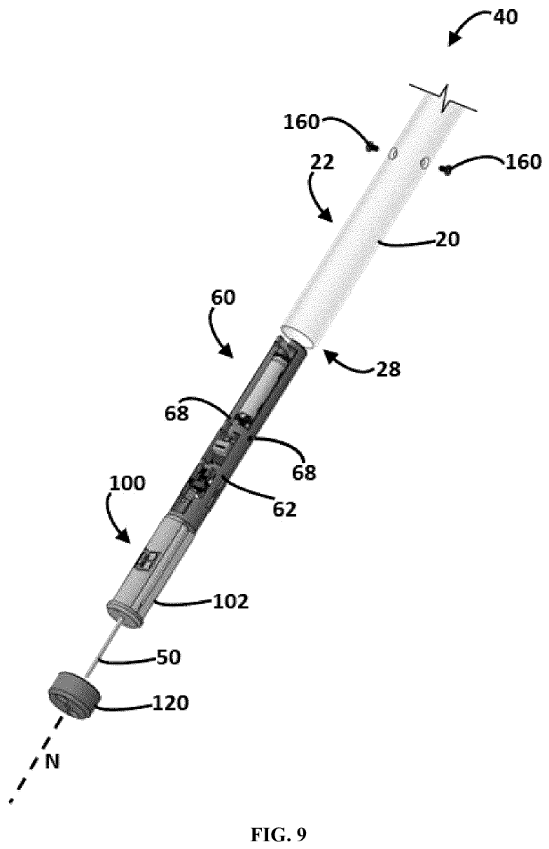

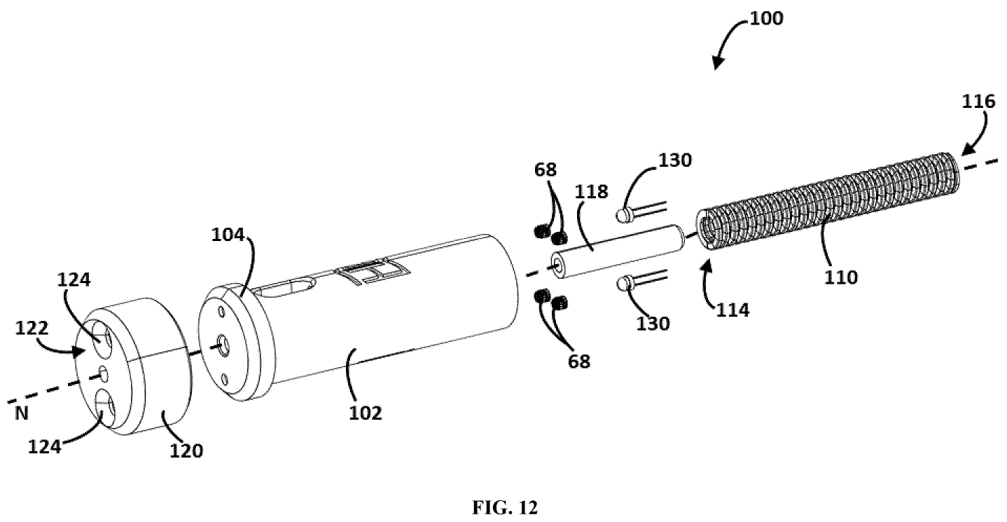

Referring now to FIG. 12, the spring enclosure 100 broadly comprises a spring enclosure housing 102, a bias spring 110 (more generally, a bias element), a bias spring spacer 118, shock cap 120, and white LEDs 130 that can be operatively connected to the user interface assembly 140 discussed in greater detail below. The enclosure housing 102 has an end cap 104, which defines a pair of light recesses 106 into which the LEDs 130 can fit. It will be appreciated that the shock cap 120 defines corresponding light apertures 124 which allow the transmission of light from the LEDs 130 during operation. The shock cap 120 is preferably made of a resilient material capable of absorbing impacts and defines an outer contact surface 122 that is configured to protect the apparatus 10 from contact damage with manufacturing structures during use, e.g., when the adhesive bond of a fastener being tested fails and the apparatus subsequently collides the structure to which the fastener was previously attached (see FIG. 9). The bias spring 110 has a first end 114 and a second end 116 that are configured to engage the flange 54 of force pin 50 and the sensor module housing base 64, respectively, during operation of the apparatus 10 (see FIG. 8). The bias spring spacer 118 is configured generally to fit around the free end portion 56 of force pin 50 and fit inside the bias spring 110 for alignment during operation.

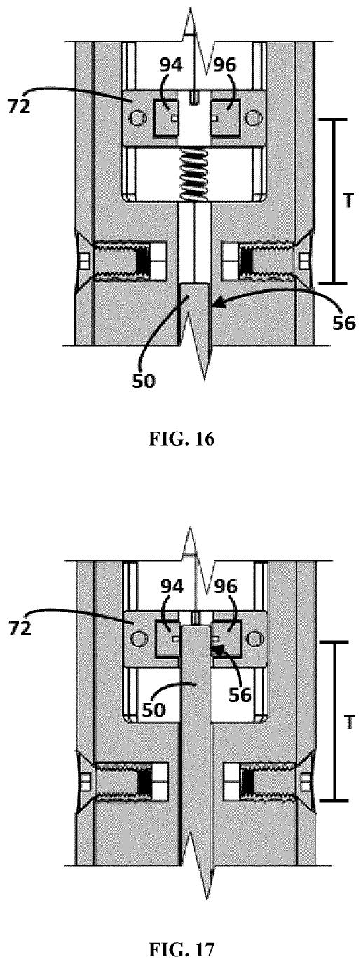

The bias spring 110 is positioned between the flange 54 and sensor module housing base 64 to yieldably bias the force pin 50 to an extended position. During use, a user gripping the apparatus 10 by the handle portion 24 can press the contact end portion 52 against a fastener 190 and apply force. The bias spring 110 will gradually yield (e.g., compress) as greater force is applied. The yielding of bias spring 10 allows for retraction of the force pin 50 into the body 20 of the apparatus 10. The free end portion 56 of the pin 50 retracts into the sensor module 60. When the device is properly calibrated, the free end portion 56 will cross the region between diodes 94, 96 once a predetermined threshold force is reached, as shown in FIGS. 16-17, at which point the encoder 92 of optical sensor 90 will issue a signal.

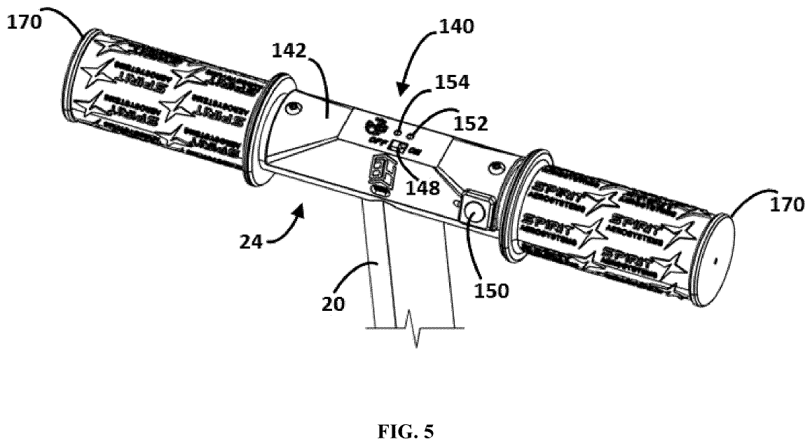

Referring now to FIG. 5, handle portion 24 of body 20 is shown with user interface assembly 140 (more generally, an indicator) and handle grips 170 installed. Referring further to FIG. 6, the user interface assembly 140 includes a cover 142 and an electronic accessory including a circuit board 144, a power module 146, a power switch 148, a push button switch 150 (more generally, a switch), a green LED 152 (more generally, a power indicator), a blue LED 154 (more generally, a first threshold force indicator), a speaker 156 (more generally, a second threshold force indicator), and cover screws 158 to fasten the cover to the housing 20. It will be appreciated the user interface assembly 140 can be electronically coupled to the electronic components in the force detection assembly 40, via either a direct physical connection or wireless signal transmission. For example, it is contemplated that the white LEDs 130 can be activated and deactivated via the push button switch 150 and/or the control system 200 discussed below.

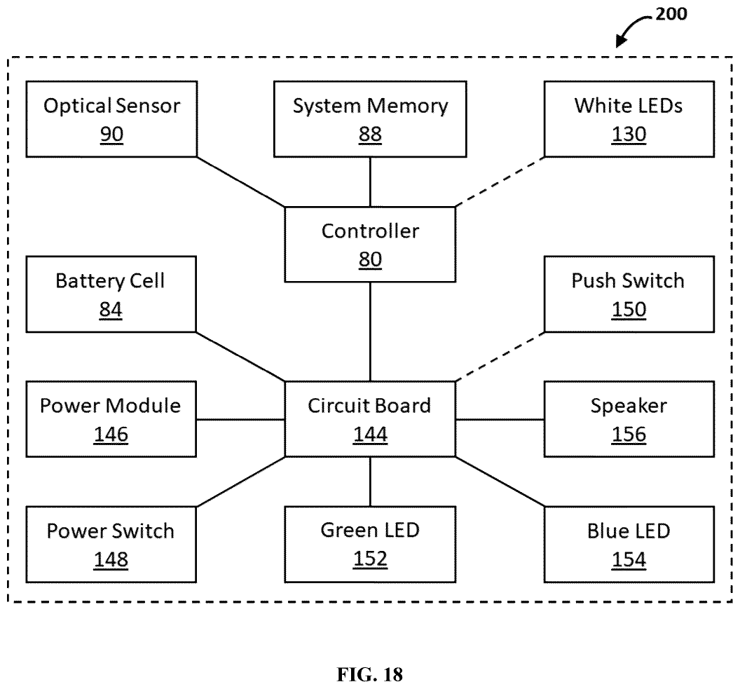

Referring to FIG. 18, an exemplary control system for the force-testing apparatus 10 is shown schematically and generally indicated at reference number 200. The control system 200 generally interconnects the features of the force detection assembly 40 and user interface assembly 140 (more generally, force detection features) for integrated operation of the apparatus 10, and such connection can be achieved by numerous combinations of physical and/or wireless connections as would be apparent to those in the field. The control system 200 broadly comprises the controller 80, the battery cell 84, a system memory 88 (more generally, a tangible, non-transitory storage medium), the optical sensor 90, the circuit board 144, the power module 146, the power switch 148, the green LED 152, the blue LED 154, the speaker 156. The control system 200 can optionally include the push button switch 150 and white LEDs 130 which can operate in tandem with the force detection features or largely independently. As shown in FIG. 18, the controller 80 is operatively coupled to the system memory 88, the optical sensor 90, the white LEDs 130, and the circuit board 144. The circuit board 144 is further operatively coupled to the power switch 148, power module 146, and battery cell 84, the push button switch 150 (more generally, a light switch), the green LED 152, the blue LED 154, the and the speaker 156. As described in greater detail below, the control system 200 is configured to regulate the activation of the LEDs 130, 152, 154 and speaker 156 during operation of the apparatus 10.

Referring further to FIGS. 2-3 and 13, an example of equipment with which the apparatus 10 can be used can broadly comprise a manufacturing structure, such as the sheet 180, and a fastener, such as the adhesive-bonded nutplate 190. It is contemplated the sheet 180 is made of sheet metal, such as stainless steel or aluminum, and includes a non-contact surface 182 and a contact surface 184 to which the nutplate 190 can be affixed. It will be appreciated that the apparatus 10 is primarily configured to test the bond strength of fasteners installed on contact surfaces that face generally away from the handles of the apparatus. Of course, a wide variety of other manufacturing structures like beams, channels, frames, etc. with one or more suitable contact surfaces for affixing fasteners as contemplated herein may be used alternatively. In this embodiment, an alignment hole 186 is formed through the sheet 180 and extends between the non-contact surface 182 and contact surface 184.

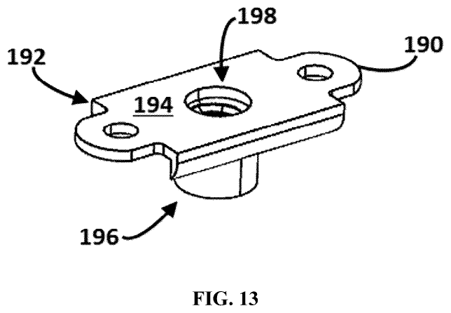

As shown in FIG. 13, the nutplate 190 includes a base portion 192 with a base surface 194 that is configured to be adhered to the contact surface 184. Additionally, the nutplate 190 has a fastener portion 196 that extends outward from the base portion 192 in a direction away from the base surface 194 and adjoins the base portion along a fastener base region 198. The fastener portion 196 has a threaded interior that is configured to receive an auxiliary bolt (not pictured). As discussed generally above, it is contemplated that the nutplate 190 can be affixed to the sheet 180 directly over the alignment hole 186 with the assistance of a removable installation feature (not shown). It is contemplated that other types of connectors, studs, tie mounts, and other similar features can be affixed and subsequently used with the apparatus 10 without departing from the scope of the invention. As best seen in FIG. 15A, the contact end portion 52 of the force pin 50 is preferably dimensioned to engage at least some of the base portion 192 and/or the fastener base region 198 and is generally too large to travel through the entire nutplate 190 or other equivalent fasteners when the apparatus 10 is used.

Turning now to FIGS. 2-3, 5, 14-17, and 19, an exemplary method of using the apparatus 10 will be described. While the following description focuses on using the apparatus 10 in an upright position by a standing user, it is contemplated that the apparatus can be held and used in other positions and orientations depending on the location and orientation of the fasteners being tested relative to the user (e.g., upward/vertical, forward/horizontal).

Referring first to FIG. 5, before testing the bond strength of the nutplate 190, the force detection features can be turned on by actuating the power switch 148. The white LEDs 130 may optionally be activated by actuating the push button switch 150. As shown in FIGS. 2, 3, and 15-15A, the apparatus can then be positioned generally above the alignment hole 186 on the side of non-contact surface 182 by the standing user. By further movements of the standing user, the contact end portion 52 of force pin 50 can be inserted through alignment hole 186 and placed in contact with the base portion 192. Then, a downward force can be applied to the handle portion 24 of body 20, causing the bias spring 110 to compress between flange 54 and sensor module housing base 64 as a normal force from the adhesively bonded nutplate 190 inhibits the force pin 50 from downward motion. Referring next to FIGS. 16-17, the compression of the bias spring 110 causes the force pin 50 to move upward relative to the body 20 and reduce the distance between free end portion 56 and the optical sensor 90. When a predetermined threshold force has been applied, the free end portion 56 travels a distance T relative to the optical sensor 90 and reaches a position between diodes 94, 96 (see FIGS. 16-17). It will be appreciated that the distance T is equal to the distance that the bias spring 110 will yield during operation and thus directly corresponds to the predetermined threshold force, and any further travel represents a greater force than what is required. As described in greater detail below, the predetermined threshold force can be calibrated by adjusting the vertical position of the sensor support assembly 70 relative to the free end portion 56. Further details of the force-testing process 210 performed by control system 200 are described below. Subsequently, the downward force can be removed from the handle grips 170, causing the spring 110 to expand and return the pin 50 to its normal extended position.

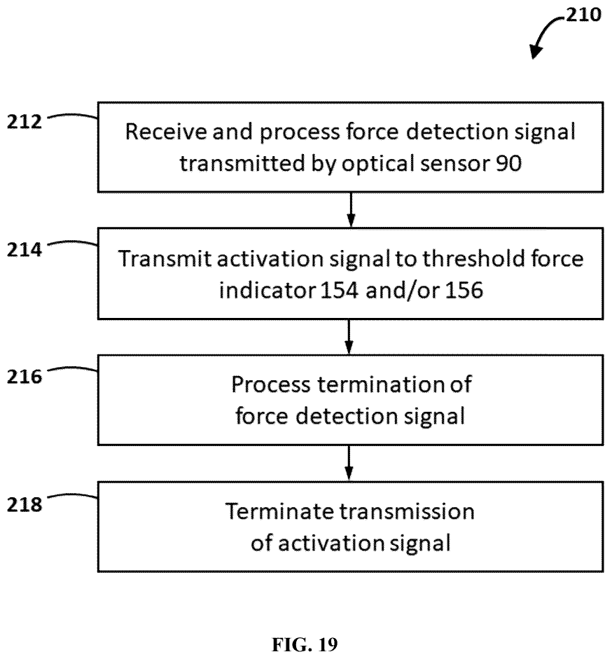

An exemplary force-testing process involving the control system 200 is generally indicated at reference number 210 in FIG. 19. In particular, the controller 80 can be configured to run the force-testing process 210 for detecting when the free end portion 56 reaches the position between diodes 94, 96, at which point the optical sensor 90 creates an indicator signal for indicating that the threshold force has been achieved. (As a precursor, the control system 200 must be turned on via power switch 148.) As indicated in block 212, the controller 80 receives and processes force detection signals transmitted by the optical sensor 90 when the free end portion 56 of force pin 50 is detected by diodes 94, 96. Referring next to block 214, the controller 80 transmits an activation signal (generally, an indicator signal) to one or both of the blue LED 154 and the speaker 156 to indicate that the threshold force has been achieved. The controller maintains this state until, with reference to block 216, the controller processes the termination of the force detection signal from optical sensor 90 (e.g., when force is removed from the apparatus 10 and the free end portion 56 moves away from diodes 94, 96). As indicated in block 218, the controller subsequently terminates transmission of the activation signal to the respective threshold force indicator(s). It is contemplated that other processes or feedback loops could be employed by controller 80 to achieve a similar result with the threshold force indicators as would be known in the field. As an illustrative example, an alternative process could be configured such that the controller 80 transmits an activation signal for a set period of time (e.g., 2 seconds) after the detection signal is processed. In this embodiment, the controller 80 is configured to run the force-testing process 210 by processing controller-executable functions stored in the system memory 88 associated with the functions indicated in blocks 212-218.

Referring to FIGS. 11 and 16-17, it will be appreciated that the predetermined threshold force can be calibrated by manipulating the adjustment mechanism of sensor support assembly 70. More specifically the position of the adjustment screw 74 can be adjusted by screwing and unscrewing motions. In turn, users may adjust the distance T that the free end portion 56 must travel (and the bias spring 110 must yield) to generate signals for the force testing process 210. It is also contemplated that the predetermined threshold force can be adjusted to account for irregularities, such as operating the apparatus 10 at an angle relative to the normal axis N, or to account for different tolerances and/or safety factors.

As shown in FIGS. 7A and 9, the sensor support assembly 70 is received inside the lower opening 28 of body 20 when the apparatus 10 is fully assembled, preventing access to the adjustment screw 74. Thus, the apparatus 10 must be partially disassembled, e.g., by unfastening mount screws 160 and releasing the force detection assembly 40. Once the force detection assembly 40 is released, the adjustment screw 74 is accessible for adjustments or calibrations. Following calibration (or re-calibration) of the sensor support assembly 70, the force detection assembly 40 can be reinstalled to the body 20.

In view of the foregoing, it can be seen that an advantage of the apparatus 10 is that it allows inspectors to quickly, reliably, and accurately test the adhesive bond strength of nutplates and other bonded fasteners from a standing position. Additionally, inspectors or workers are able to quickly identify when a predetermined threshold force has been applied via appropriately located indicators. Further, apparatus 10 is dimensioned to permit convenient access to areas of structures that may be hard-to-reach with handheld components. Further, the apparatus 10 can be equipped with protective and lighting components to facilitate everyday use with manufacturing structures. Additionally, the detachable nature of sensor components allows for controlled and protected force calibration without disruption from regular use. Other advantages will be apparent from the description and figures herein.

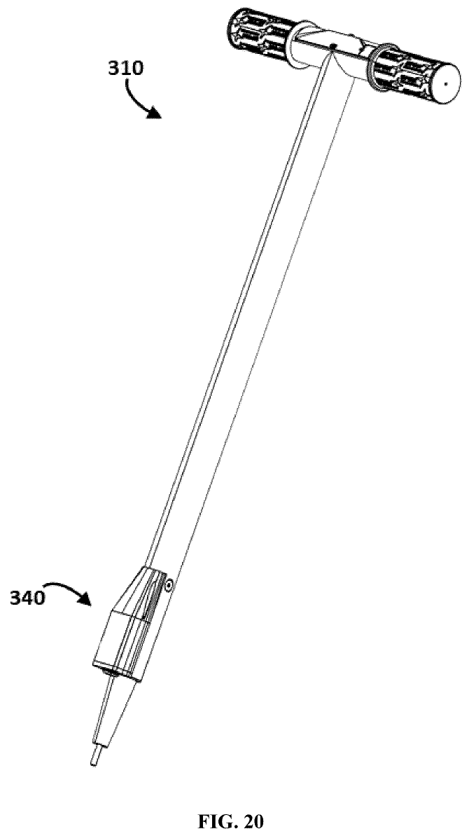

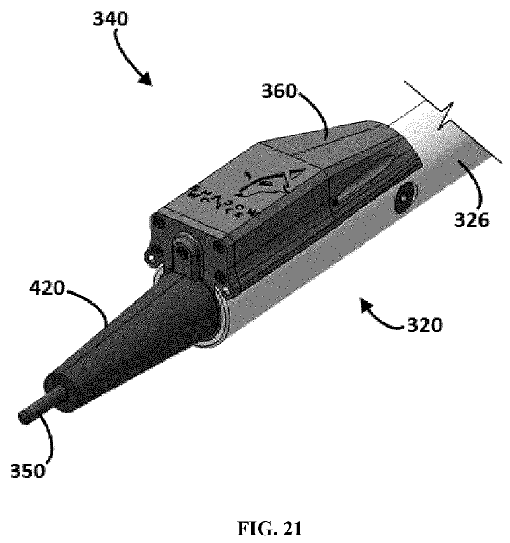

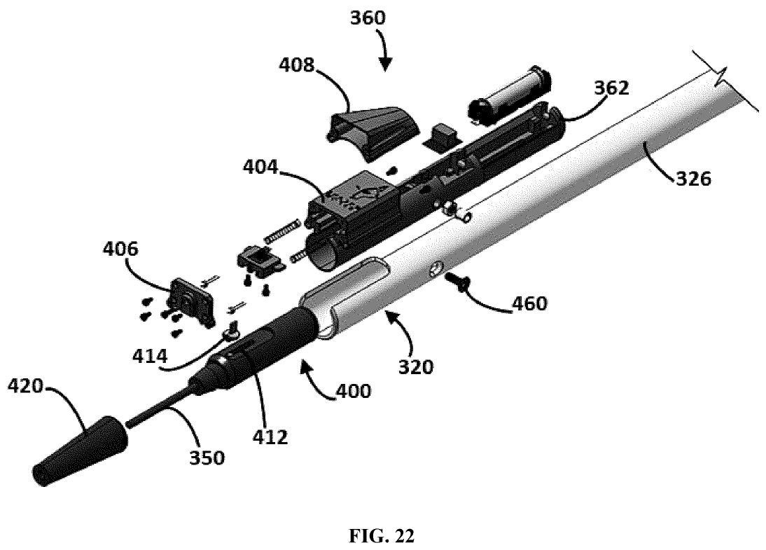

Referring to FIGS. 20-22, in an alternative embodiment, a force-testing apparatus 310 has a body 320 and a force detection assembly 340 that includes a force pin 350, a sensor module 360, a mechanical portion 400, and a contact guard 420. In this embodiment, the sensor module 360 and mechanical portion 400 are mounted to the body 320 via mount screws 460. When installed, the housing 362 of sensor module 360 is located partially outside body wall 326. It will be appreciated that the force pin 350 is coupled to an angled pin 412 that engages a tab 414 configured to interface with an adjustable sensor that is located externally of the main body 320 but is protected by external panel covers 404, 406, and 408 to prevent inadvertent adjustments. Accordingly, the sensor is adjustable by disassembling portions of the force detection assembly 340 to provide access to the interior of the sensor module 360.

Other variations of apparatuses and processes are contemplated as being within the scope of the invention. For example, the control system 200 may be configured for wireless connection to one or more remote user interfaces and/or remote indicators, including without limitation headphones and smart glasses, which would broadly be understood as peripheral components of the force-detection apparatus. Other types of indicators, such as haptic feedback devices, can be used instead of or in addition to lights or speakers.

As described above, various aspects of this disclosure pertain to computer devices and corresponding computer-implemented processes. Where this disclosure describes a controller, it is to be understood that the controller may comprise a special purpose computer including a variety of computer and electromechanical hardware, as described in greater detail herein. For purposes of illustration, programs and other executable program components may be shown or described as discrete blocks or modules. It is recognized, however, that such programs and components reside at various times in different storage components of a computing device, and are executed by a data processor(s) of the device.

Although described in connection with an example control system environment, embodiments of the aspects of the invention are operational with other special purpose computing system environments or configurations. The control system environment is not intended to suggest any limitation as to the scope of use or functionality of any aspect of the invention. Moreover, the control system environment should not be interpreted as having any dependency or requirement relating to any one or combination of components illustrated in the example operating environment. Examples of control systems, environments, and/or configurations that may be suitable for use with aspects of the invention include, but are not limited to, multiprocessor systems, microprocessor-based systems, programmable consumer electronics, personal computers, server computers, hand-held or laptop devices, set top boxes, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A force-testing apparatus adapted for standing users comprising:
a body with a handle portion;
a force detection assembly coupled to the body, the force detection assembly comprising a threshold force detector;
a plunger coupled to the force detection assembly, the plunger being configured to sustain a normal force when an operating force is applied to the body generally toward the plunger in a normal direction, the normal force opposing the operating force in the normal direction;
a signal processor operatively coupled to the threshold force detector; and
an indicator operatively coupled to the signal processor;
wherein the threshold force detector is configured to detect when the operating force reaches a predetermined threshold force value; and
wherein the signal processor is configured to transmit an indicator signal to activate the indicator when the predetermined threshold force value has been detected.

2. The force-testing apparatus of claim 1, wherein the detector is a position detector configured to detect a position of the plunger relative to the body.

3. The force-testing apparatus of claim 2, the force detection assembly further comprising a spring in yieldable engagement with the plunger, wherein the predetermined threshold value detected by the threshold force detector corresponds to a threshold compression distance of the spring.

4. The force-testing apparatus of claim 3, wherein the threshold force detector is configured to detect a position of the plunger relative to the force detection assembly.

5. The force-testing apparatus of claim 1, wherein the body has a body length of at least approximately 30 inches.

6. The force-testing apparatus of claim 1, wherein the indicator is configured to be perceived by a standing operator of the apparatus.

7. The force-testing apparatus of claim 1, wherein the indicator is coupled to the handle portion of the body.

8. The force-testing apparatus of claim 1, wherein the indicator comprises at least one of a visual indicator or a sound indicator.

9. The force-testing apparatus of claim 1, the plunger comprising a contact end portion:
wherein the contact end portion is configured to extend through an aperture formed in a manufacturing structure to reach a portion of a fastener installed to the manufacturing structure on a distal surface of the manufacturing structure, the distal surface facing generally away from the force-testing apparatus in the normal direction; and
wherein the plunger is configured to sustain the normal force by placing the contact end portion in abutting engagement with said portion of said fastener.

10. The force-testing apparatus of claim 9, wherein the contact end portion is configured to fit in apertures having a diameter of up to approximately 0.5 inches.

11. The force-testing apparatus of claim 9, wherein the contact end portion is substantially rigid.

12. The force-testing apparatus of claim 1, wherein the force detection assembly is adjustable to detect more than one predetermined threshold force value.

13. The force-testing apparatus of claim 12:
wherein the force detection assembly is releasably coupled to the body, and
wherein the force detection assembly and body are configured to inhibit adjustment of the force detection assembly while the force detection assembly is coupled to the body.

14. The force-testing apparatus of claim 9, further comprising a guide light disposed near and configured to direct light toward the contact end portion of the plunger.

15. The force-testing apparatus of claim 9, further comprising a shock cap, the shock cap being disposed on a portion of the body near the contact end of the plunger,
wherein the contact end of the plunger extends outward from the shock cap generally in the normal direction, and
wherein the shock cap is configured to protect against impacts between the manufacturing structure and the portion of the body to which the shock cap is disposed.

16. The force-testing apparatus of claim 1, further comprising a non-transitory storage medium coupled to the signal processor, wherein the signal processor is configured to perform signal processor-executable instructions stored in the non-transitory storage medium, the signal processor-executable instructions being configured to, when executed by the signal processor, execute a force-testing process by:
determining when the predetermined threshold force value has been detected by the threshold force detector; and
transmitting an indicator signal to activate the indicator when the predetermined threshold force value has been detected.

17. A force-testing apparatus adapted for standing users comprising:
a body having a handle portion and a shaft portion extending from the handle portion, the shaft portion having a distal end portion and a length extending from the handle portion to the distal end, the length being at least 18 inches;
a contact end portion at the distal end of the shaft portion, the contact end portion configured to contact a part;
a force sensor; and
an indicator located on the handle;
wherein the contact end portion is configured to be urged against the part by a compressive force applied manually to the handle portion;
wherein the force sensor is configured to detect when the compressive force reaches a predetermined threshold force value; and
wherein the indicator is operatively coupled to the force sensor and is configured to indicate when the predetermined threshold force value is reached.

18. The force-testing apparatus of claim 17, wherein the force sensor is adjustable to multiple different predetermined threshold force values.

19. A force-testing apparatus comprising:
a body with a handle portion;
a plunger in spring-biased engagement with the body at a distal end of the body opposite the handle portion;
a signal processor;
a position detector operatively coupled to the signal processor; and
an indicator operatively coupled to the signal processor;
wherein the plunger is configured to sustain a normal force when an operating force is applied to the body generally toward the plunger in a normal direction, the normal force opposing the operating force in the normal direction;
wherein the plunger is configured to travel a compression distance relative to the body, the compression distance corresponding to the magnitude of the operating force;
wherein the position detector is configured to transmit a detection signal when the plunger travels at least a threshold compression distance corresponding to a predetermined threshold operating force; and
wherein the signal processor is configured to transmit an activation signal to the indicator when the position detector transmits the detection signal.

20. The force-testing apparatus of claim 19,
wherein the indicator is located on the handle of the body; and
wherein the indicator comprises at least one of a visual indicator or a sound indicator.
